(19) United States
(12) Patent Application Publication
(10) Pub. No.: US 2009/0055231 A1
(43) Pub. Date: Feb. 26, 2009

(54) System and a Method of Individualization of Animals and Herd Management

(75) Inventor: José Pereira Benza, Asuncion - Paraguay (PY)

Correspondence Address: BIRCH STEWART KOLASCH & BIRCH, PO BOX 747, FALLS CHURCH, VA, 22040-0747, US

(73) Assignee: DOMINAR PECUARIA DE PRECISAO S.A., Aparecida De Goiania-Go (BR)

(21) Appl. No.: 11/918,225

(22) PCT Filed: Apr. 13, 2006
(86) PCT No.: PCT/BR2006/000071

§ 371 Date: Mar. 20, 2008

(30) Foreign Application Priority Data
Apr. 14, 2005 (BR) PI0501314-3

(51) Int. Cl. G06Q 30/00; A01K 29/00; G09F 3/00

(52) U.S. Cl. 705/7; 119/174; 40/300

(57) ABSTRACT

The present invention is particularly applicable to cattle and buffalo livestock, and allows the individualization of animals by observation of codes and characteristics that are visually perceptible and available in various manners in the animal in order to allow the correlation of the information collected in non-electronic means and relative to the management practices performed on the animals at any phase of breeding thereof, providing an unambiguous individualization of the animal for subsequent inclusion in a database. The said identification is provided by a combination of at least, a portion of an Integral Code with a portion or a complete sequence of another Integral Code, according to standards previously defined by the managers/administrators of the system. One of the Integral Codes may be compatible with the ISO 11784 or equivalent standards, and the other, not related to the said standards, may be assigned to the animal by a specific entity, by the owner or the manager of the herd. The selected characters, which make up the portions of the identification codes and may occupy contiguous or non-contiguous positions within the said codes, are visually perceptible and available in different manners in the animal. the order of the sequence of elements used to achieve the individualization of the animal is not fixed and shall be previously defined by the managers/administrators of each system.

### FIELD OF THE INVENTION

The present invention is related to the field of animal husbandry, and refers particularly to data collection for herd control using databases, with particular application to cattle and buffalo livestock.

### DESCRIPTION OF THE PRIOR ART

The increasing internationalization of animal husbandry activities, which is reflected in the growing volume of beef exported from Brazil, requires an increasingly strict control of the conditions of the cattle and buffalos, implying the ability to individually track each animal. This control is essential to ensure uniform quality if the exported products, especially regarding the absence of diseases that might cause contamination of the herds in the importer countries.

Furthermore, the economic pressures arising from domestic and worldwide competition require the adoption of increasingly sophisticated techniques by the cattle production industry, including the ability to selection of the most productive varieties and/or those best adapted to the conditions of each region of the producing country.

The majority of the procedures most lately developed to individualize the livestock and to control herds make use of sophisticated techniques that involve control by electronic means, requiring equipment of relatively high cost, making such equipment difficult to be afforded by lesser-scale producers. Thus, for example, there are already known and used devices that implanted in the animal (Radio Frequency Identification Device—RFID) transmit radio frequency signals captured by electronic reading equipment, such as exemplified in U.S. Pat. No. 5,322,034, allowing access to a database to add additional information to the initial enrollment log, during the lifetime of the individual animal. The referred patent does not describe in detail the process of collection of the additional data that will be recorded in the implanted module, and rather emphasizes the composition of the said module and of the fixed data transmission and readout unit.

In U.S. Pat. No. 5,211,789 a method and a system for manual collection of information relative to each animal for its later initial enrollment into a database are described. In that patent, data cards for manual data entry are supplied to the breeder in the form of a kit which further includes an RFID and a visual identification ear tag (“visual identification tag”), packed in a plastic bag. The breeder opens this bag, applies the RFID and the visual ear tag to the animal, and simultaneously fills in the initial enrollment form contained in the supplied data card informing certain individual data of the animal, and subsequently sends these initial enrollment data cards to a management entity where the said initial enrollment information is fed to a database.

Although the object of that patent is to provide breeders a low-cost system to collect the animal's initial enrollment data at the time of its identification and the subsequent of such information in databases, it is noted that the proposed system does not provide for the manual gathering of additional information relative to the management practices taken on the registered animals after their initial enrollment in the database. Therefore, said invention suggests or assumes that in order to enter information relative to management practices taken on the animal (vaccination, insemination, etc.) after its initial enrollment in the database, such data collection will be made by electronic means (RFID scanning) and not by visual or manual means anymore. Furthermore, although patent No. U.S. Pat. No. 6,211,789 contemplates the possibility of affixing a visual identification element to the animal, it does not provide details concerning the characteristics of such element, such as the amount of characters and the dimensions thereof, merely mentioning that “preferably” the visual code should be correlated to the unique identification code, which is the one that is contained in the RFID device.

### OBJECTS OF THE INVENTION

In light of what has been set forth above, a first object of the present invention consists in the provision of a system and a method for sufficient individualization of animals dispensing the need of using electronic equipment such as RFID transponders, RFID readout devices, bar code scanners and similar elements.

A second object of the invention consists in the provision of a system to allow easy and accurate capture, collection and/or recording of information relative to management practices taken on the animals previously enrolled in a database to thereby allow the later inclusion of such additional information in an easy and accurate manner.

A third object of the invention consists in the provision of a system whereby the animal is individualized by means of a direct use of certain Derivative Codes, and optionally, of Specific Signals, with a low operational cost, irrespective of the fact that the same animal may also be individualized by an RFID.

A fourth object of the invention consists in the provision of a system for individualization of animals based on signs that are visually perceptible in the animal, that may be easy to transcribe, encode and/or record by low-skilled or unskilled personnel.

### SUMMARY OF THE INVENTION

The above listed objects and others are achieved by means of a system whereby each animal is individually identified by a combination of two or more Derivative Codes, at least one of these constituting a portion of an Integral Code, also optionally including one or more Specific Signals, in accordance with rules previously and adequately defined by the managers/administrators of the system in use and implemented in the software used to manage the database of such system, where the animal was previously registered.

The managers/administrators of the system in use (and of the software) that manages the respective database must format the Resulting Code, that is, they will previously define and select the order, the specific characters, the quantity of characters of each Derivative Code, and optionally, which Specific Signals will be used to comprise the Resulting Code. All of these actions are intended to adequate and interpret this information in order that, based on manual entries, subsequently registered in the system, the software be able to locate and retrieve from the database, in an unambiguous manner, the corresponding Integral Codes that individually identify each animal.

According to another characteristic of the invention, at least one of the cited Derivative Codes comprises characters in selected positions in the set forming the respective Integral Code.

According to a further characteristic of the invention, one or more of the respective Integral Codes may consist in a code compliant with the ISO 11784 standard or similar standards.

According to one other characteristic of the invention, said characters are located in contiguous or non-contiguous positions within the respective Integral Code.

According to still another characteristic of the invention, one or more of the respective Integral Codes may be the Code used to register the animal with a specific entity or any Code, provided that the same allows the individualization of the animal at least in relation to its group or herd. The said specific entity may consist in any governmental or non-governmental organization, any breeder, association of breeders or herd manager.

According to another characteristic of the invention, at least one of the Integral Codes may consist in the SISBOV Number, the RGD (“Registro Genealógico Definitivo”—Definitive Genealogic Registration) of the ABCZ (“Associação Brasileira de Criadores de Zebu”—Brazilian Association of Zebu Cattle Breeders), the birth code attributed to the animal in a private fashion, the serial code of inclusion of the animal in confinement, among other admissible options.

According to another characteristic of the invention, the updating of information on the animals comprises entry of data in spreadsheets, such spreadsheets comprising specific fields for individualization that are filled with the two of the said Derivative Codes as well as, additionally and optionally, with Specific Signals.

According to another characteristic of the invention, the said fields may be positioned in the spreadsheet contiguously or interspersed with fields intended for other information.

According to a further characteristic of the invention, said spreadsheets are organized in the form of rows and columns, each row or set of rows being intended for registration of the information related to each animal and each column being intended for registration of the Derivative Codes, the Specific Signals and the information concerning management practices taken on the animals, and those columns relative to the Derivative Codes and Specific Signals may be contiguous or interspersed with those intended for registration of the management practices taken on the animals.

According to one other characteristic of the invention, the updating of information on the animals comprises the input of the Derivative Codes, the Specific Signals and the information on management practices taken on the animals directly to a computer or terminal, which may be of a fixed or portable type.

According to a further characteristic of the invention, the said input may be effected in a fractional fashion, there being initially input one or more Derivative Codes, Specific Signals and/or other information to the computer or terminal, and inputting another additional part in response to request messages generated by the computer or terminal.

According to another characteristic of the invention, the said inputs may be effected by typing on a keyboard, voice locution for speech recognition systems, or by marking certain areas or check boxes directly onscreen by means of a pointer or mouse or yet by means of manual writing on the screen of computers provided with a writing recognition and digitizing software, such as palmtop or similar devices.

According to another characteristic of the invention, the process of individualization of the animal comprises the above cited combination of two or more Derivative Codes, at least one of these constituting a portion of the Integral Code, and may further include one or more Specific Signals, which input is made according to a certain specific situation anticipated by the system managers.

Finally, the set comprising the said Derivative Codes and Specific Signals, irrespective of their order of input, constitutes the Resulting Code, which upon being input to computers provided with adequate software, such as, for example, the specially adapted version of the software named “BeefLink” available in Brazil with the name “Dominar”, allows an absolute individualization of the animal, and thus the retrieval from, or location in, the database, in an unambiguous manner, of the various Integral Codes correlated in the database, as well as the previous data stored in the database, and also allows precise inputting of additional information regarding the management practices taken on the animal, having been detected, collected or recorded after the initial registration of the animal in the database.

### DESCRIPTION OF THE FIGURES

Additional characteristics and advantages of the invention will become more apparent in the description of the preferred embodiments of the invention, given by way of example and not to be construed in any limitative sense of the instant invention, and in the figures referring thereto, wherein:

FIG. 1 depicts a bovine specimen with Derivative Codes recorded in the Identification Elements attached to the right and left ears and several Specific Signals.

FIG. 2 shows one of the possible patterns of organization of the recording of Codes in an Identification Element, in this case an ear tag according to the standardization rules of SISBOV for attachment to a first ear of the animal.

FIG. 3 shows one of the possible patterns that can be used to organize the recording of Codes in an Identification Element, in this case a button-type ear tag for attachment to a second ear of the animal, in a first embodiment of the invention.

FIG. 4 shows a bovine specimen with various Codes and Specific Signals recorded in an Identification Element (in this case a conventional ear tag) attached to one ear and a Code (in this case the RGD code of the ABCZ entity) marked by branding with a hot iron.

FIG. 5 shows in detail a possible pattern to be used for organizing the recording of Codes and Specific Signals in an Identification Element, in this case a button-type ear tag, for attachment to one of the animal's ears, in a second embodiment of the invention.

FIG. 6 shows an example of a spreadsheet for manual recording of events related to the animals, individualizing the same by means of a combination of a first Derivative Code (the “MANEJO” [MANAGEMENT PRACTICES]), in this case consisting in the part of up to six digits of the respective Integral Code, which may consists in a quantity of characters lesser than, equal to or greater than six, with a second derivative Code (the “ISO”), in this case consisting in the portion of the last three characters of the respective Integral Code, with is an ISO-compatible Code of 15 digits, with a Specific Signal, in this case the gender of the animal, according to the invention.

FIG. 7 shows a second possible pattern of organization and recording of Codes and Specific Signals in a conventional ear tag.

FIG. 8 shows a third possible pattern of organization and recording of Codes and Specific Signals in a conventional ear tag.

FIG. 9 shows various Codes and Specific Signals organized and recorded in a male-female assembly of Identification Elements formed by a conventional ear tag and a button-type ear tag, for attachment to both faces of the animal's ear.

FIG. 10 shows one other form of organizing the recording of Codes in an Identification Element, in this case consisting in a button-type ear tag.

### DETAILED DESCRIPTION OF THE INVENTION

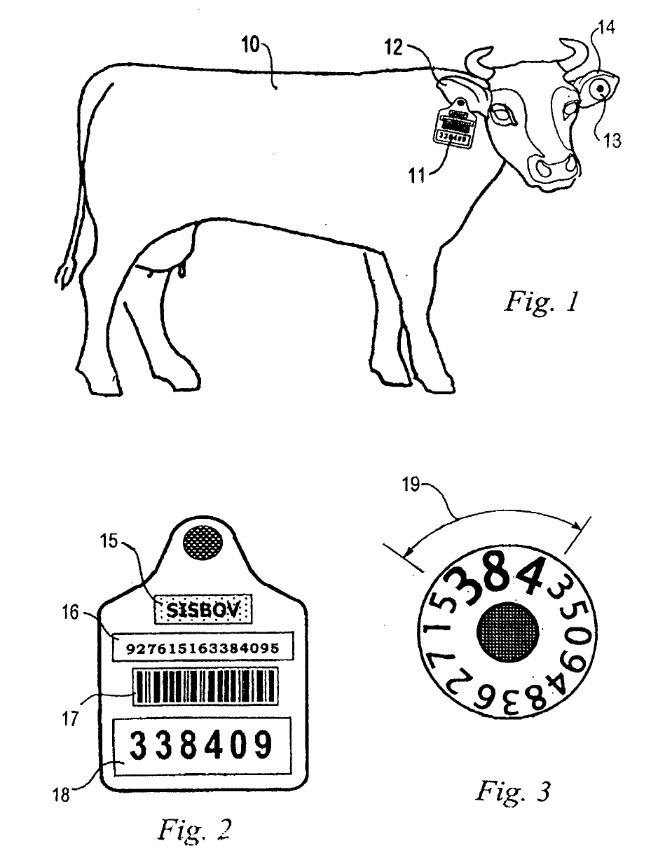

Referring now to FIG. 1, there is shown a bovine specimen 10 with two Identification Elements, the first consisting in a conventional ear tag 11 attached to the right ear 12 and the second consisting in a button-type ear tag 13 attached to the left ear 14. the Code(s) recorded in the said first conventional ear tag may be of entirely private origin or of the type issued by a breeders association—such as, for example: “Associação dos Criadores de Gado Jersey” [Association of Breeders of Jersey Cattle], the RGD (Registro Genealógico Definitivo—Definitive Genealogical Registration), ABCZ (Associação Brasileira dos Criadores de Zebu—Brazilian Association of Breeders of Zebu Cattle), Holstein Cattle Association and similar organizations—or a domestic-scope governmental control entity, such as the SISBOV, depicted in the figure. The button-type ear tag, normally of circular shape, has recorded therein a Code that is different from the one recorded in the conventional ear tag, and may be compatible with the rules of the ISO-11784 standard, irrespective of including or not an RFID device.

FIGS. 2 and 3 depict in a larger scale, respectively, possible patterns to organize the recording of Codes, in Identification Elements, one in the form of a conventional ear tag in accordance with the SISBOV standard and the other in the form of a button-type ear tag, configured in accordance with the principles of the present invention. There may be noted, in the conventional ear tag of FIG. 2, four information fields, the first field 15 identifying the originating entity, in this case the SISBOV itself, the second field 16 containing the SISBOV Integral Code of 15 numerals, the third field 17 including the bar code corresponding to the Integral Code of field 16 and the lower field 18 containing the Derivative Code named the “Número de Manejo SISBOV” [SISBOV Management Practices Number] which consists in a sequence formed by the 9^{th} to 14^{th} numerals of the full code. It should be pointed out that the organization pattern for recording the Codes in the Identification Element is merely exemplary, and there may be created, adopted, adapted and homologated other patterns, at the discretion of the individuals that are in charge of the system where the present patent technique will be used, such persons in charge configuring the application software for herd management in order to interpret the said information.

According to the principles of the invention and as shown in FIG. 3, the Code recorded in the button-type ear tag comprises an ISO-compatible Integral Code of 15 numerals, wherefrom are selected and individualized three numerals that constitute a Derivative Code, herein named the “verificador ISO” [ISO verification code], which in combination with another Derivative Code, herein designated as the “Número de Manejo” [Management Practices Number] forms the Resulting Code that will enable the adequate software to locate the Integral Codes of the animal in a non-redundant manner in the database. Also as illustrated, the three numerals of the Derivative Code are printed in a larger font size 19, rendering the same able to be read from a certain distance and avoiding confusion from the part of the operator. Such enhancement becomes indispensable when there are selected to compose the said Derivative Code, herein named the “verificador ISO” [ISO verification code], numerals in positions other than the last ones, where the said numerals may be positioned contiguously or interspersed within the ISO-compatible code.

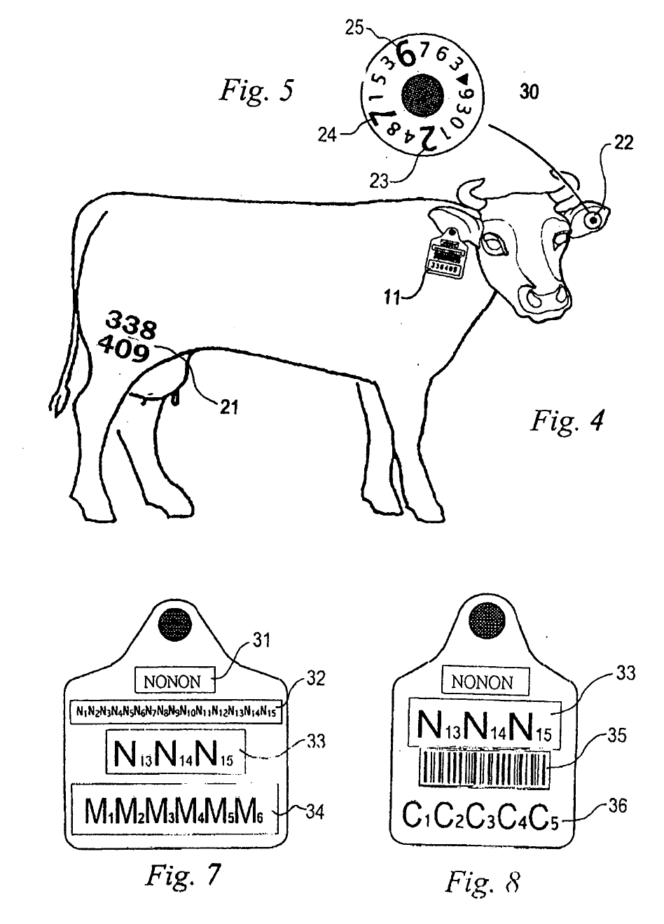

This possibility is illustrated in FIGS. 4 and 5, the first of which shows an animal branded on the right-side thigh 21 in the form of the Integral Code “CSCC3384” which is the code attributed by the ABCZ entity to individualize the same in the “Registro Genealógico Definitivo” (RGD) [Definitive Genealogical Registration] of that institution. The Codes recorded in the Identification Element in the form of button-type ear tag 22 attached to the left ear 14 are detailed in FIG. 5, wherein may be observed the ISO-compatible Integral Code “930124871536763”. Differently from what occurs with the Derivative Code recorded in the button-type ear tag 13, shown in detail in FIG. 3, in this case the numerals selected to comprise the Derivative Code, herein named the “verificador ISO” [ISO verification code], do not occupy contiguous positions, but instead occupy interspersed positions. In the present exemplary case, there were selected the numerals that occupy the fifth position 23, the eighth position 24 and the twelfth position 25, in order to form the sequence “276” that constitutes the Derivative Code, herein named the “verificador ISO” [ISO verification code], to be combined with another Derivative Code formed by the last three digits of the animal's RGD to obtain the Resulting Code “276CC3384” or “CC384276”, depending on the case. The figure further shows an optional signal 30, indicative of the beginning of the numeric code and the readout direction.

In another embodiment of the invention, the same Identification Element—a conventional ear tag or a button-type ear tag—may include in a first field, a first Integral Code, a second field containing in an enhanced form the Derivative Code consisting in certain numerals of the said Integral Code recorded in the first field, and in a third field, a Derivative Code formed from a second Integral Code, that will be combined with the Derivative Code of the second field to form the Resulting Code to individualize the animal, according to the principles already set forth regarding the invention. FIG. 7 depicts Codes, and Specific Signals, organized and recorded in an Identification Element, in this case a conventional ear tag, conceived in accordance with this embodiment, wherein the information in field 31 identifies the organization that controls the herd. The ISO-compatible Integral Code is recorded in the first field 32, and in field 33 below that field there are printed in a larger font size, the numerals that constitute a Derivative Code. The third field 34 contains another Derivative Code, the “handling” number of the animal, which as already stated, consists in a sequence of numerals extracted from the Integral Code attributed by the controlling organization (in the case of the SISBOV, this “handling” number comprises the numerals that occupy the 9^{th} to 14^{th} positions of the full code, which is not completely printed in this Identification Element).

The Codes may comprise letters in addition to numerals, and such resource allows the reduction of the number of characters, therefore facilitating the manual input of information, such as recording of entries in a spreadsheet. FIG. 8 illustrates this possibility, where the recording pattern of Codes in a conventional ear tag shown in the figure presents, in field 33, the Derivative Code, herein named the “ISO verification code”, formed from the ISO-compatible Integral Code that is recorded in full by means of a bar code in field 35. In the lower field 36, which corresponds simultaneously to the second Integral Code of the animal and to its coincident Derivative Code, there exist 5 characters, where such characters may consist of either numerals or letters, in any order.

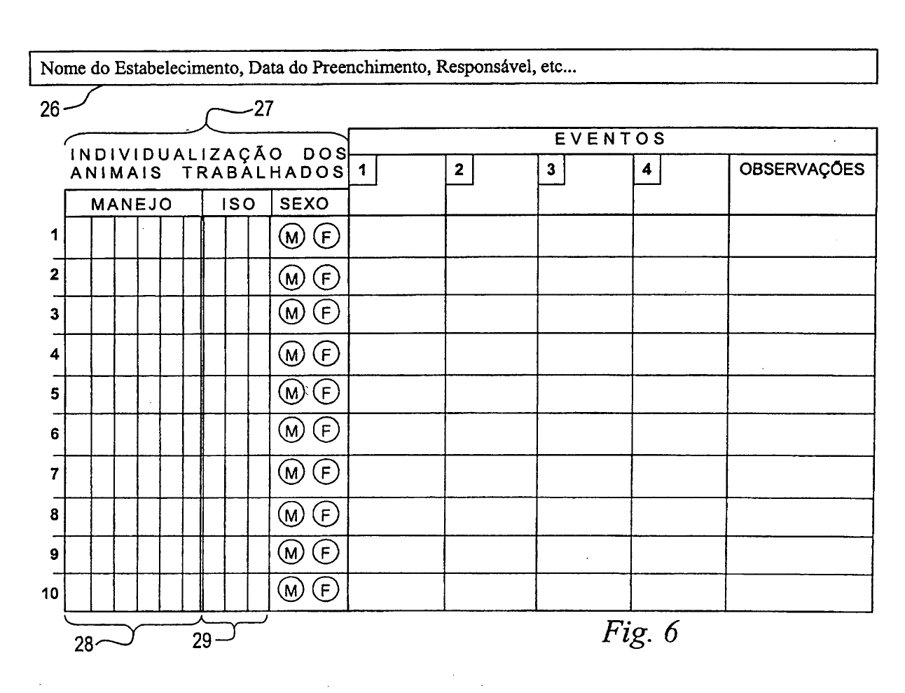

As mentioned in the list of objects of the invention, the proposed system is intended to allow, in additional to the initial registration of the animal in a database, the insertion of subsequent events, such as the application of vaccines, parasiticides intended to kill cattle ticks, feeding treatments, sanitary treatments, reproductive treatments and others. This purpose is achieved by entering data relative to the treated animals in spreadsheets wherein the animals are individualized in accordance with the principles of the invention. FIG. 6 shows a spreadsheet of the cited type, which allows manual collection of data on the individual treatments to which various animals are subjected. The illustrated spreadsheet is merely exemplary, and may include other fields and items in addition to those included in this figure, depending on the system's specifications. In the specific case of FIG. 6, the spreadsheet includes a header 26 wherein is recorded general information, such as the name of the breeding property, a date, a time, the name of the person that entered the data, and other data of interest. The individualization of the animals is made by means of entry of at least two Derivative Codes, at least one of these consisting in a portion of the Integral Code, and may further include one or more Specific Signals, all visually perceptible in the animal. In the explanatory spreadsheet of FIG. 6 there is used for the said entry the group of columns 27, comprising the subgroup 28 wherein are entered the Derivative Code consisting in the last 6 numerals of the handling number and subgroup 29 wherein is entered a second Derivative Code consisting of 3 numerals with the designation “ISO verification code”. In the example at issue, there are used 3 numerals to make up the said verification code, however it is possible to use a lesser or greater quantity of numerals, within the principles of the invention. The column without reference, relative to the Specific Signal, consisting in the gender codification of the animal, is self-explanatory, and its positioning adjacent to the right of column 29 as shown is not mandatory, as it may be positioned in another location in the spreadsheet. If the system requires the input of more Codes, or more Specific Signals, in order to individualize the animal in an unambiguous manner, the columns intended for the respective entries may similarly be located next to the columns intended for the said Derivative Codes or at a distance from the same, and may further be positioned in a location not adjacent to the columns intended for the first and second Derivative Codes.

As to the events, they may be described at length or by means of appropriate codes, such as, for example: application of a vaccine and administration path thereof, parasiticide treatment for cattle tick infestation, insemination and others. The layout of the event columns as well as their quantity will depend on the needs of the producers or may be standardized by the herd control agencies or associations. Once filled in, these spreadsheets are conveyed for registration of the events in the database, where the access to the field corresponding to each animal is achieved by keying in the components of the Resulting Code according to the terms of the present invention.

One other option for inputting the data relative to the animals consists in their direct recording in data processing equipment, by the operator in charge of visual reading of the Derivative Codes and the Specific Signals that will make up the Resulting Code. The said input may comprise keying in the said information in data input devices of fixed computers or data input terminals, or yet, in portable computers, notebooks palmtops or equivalent devices, where the latter may be equipped with speech recognition means, for subsequent conversion to other formats, thereby eliminating the need of manual record keeping and probably also the need of typing or keying operations. The input may further be effected in parcels and in any order, provided that the software has been programmed accordingly by the persons in charge of the system. Thus, for example, the operator may initially type the first element of the Resulting Code, irrespective of the same being a Derivative Code or a Specific Signal, and await a response from the computer, in the form of an onscreen message or a synthesized voice message, to then input the next element of the resulting Code, and such input may be effected by typing or keying, selection from a menu presented onscreen using a mouse or pointer device (in the case of a palmtop), speech command for speech recognition systems, or yet by writing with a pointer on a touch screen associated to a computer provided with a writing interpretation and digitizing software, as occurs in certain palmtops, however not being limited thereto. Other possible message include confirmation requests (for example, S/N), requests of a new typing of certain Derivative Codes or Specific Signals. The software may further be configured such that a part of the information intended to individualize the animal be input only after the input of one or more items of information relative to handling actions, such that the Resulting Code be generated by the computer software only after completion of the said inputs.

As already described in detail, the input of the said Derivative Codes and Specific Signals in computers equipped with appropriate software, such as, by way of non-limitative example, a specially adapted version of the software named “BeefLink”, available in Brazil with the name “Dominar”, allows to fully individualize the animal, and thereby retrieve from or locate in the database both the various correlated Integral Codes that independently individualize the animal, and also the data previously stored in the database. Consequently, it also allows the precise input of additional information, relative to handling actions realized in respect of the animal, collected, taken or registered in a non-electronic manner, at any time after the initial inclusion thereof in the database.

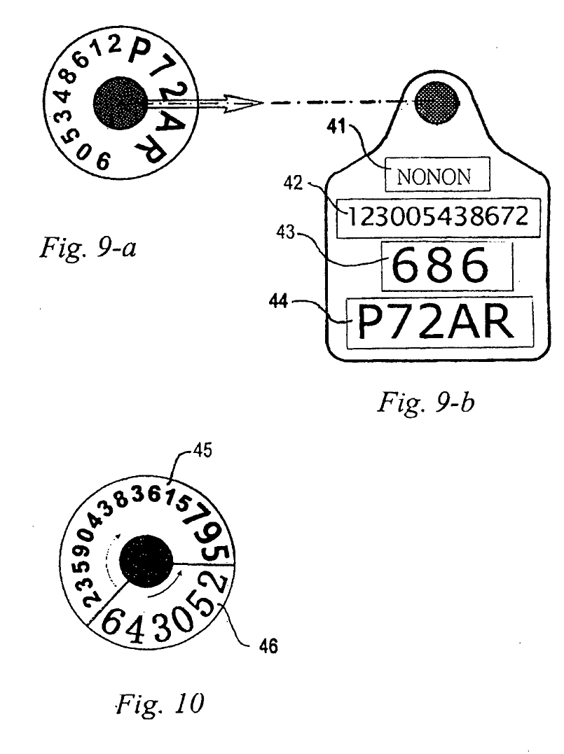

Two Identification Elements may be attached to the same ear, by means of a male-female attachment assembly, as per the possibility depicted in FIGS. 9-a and 9-b. The first shows the button-type ear tag (male element) that is attached to the rear face of the ear and has recorded therein the Integral Code designated to the animal by the controlling organization (SISBOV or equivalent entity), where it is noted that this is an alphanumeric code, wherein the last five positions, printed in larger characters, form a Derivative Code to be used as a handling number of the animal. FIG. 9-b shows the conventional ear tag (female element) attached to the ear, and attached to the button-type ear tag by a male-female type coupling arrangement. In this conventional ear tag there is recorded, from top to bottom, the following information:
field 41: acronym of the controlling organization;
field 42: first numerals of the ISO-compatible Integral Code. In the example of FIG. 9-b, the complete Integral Code comprises 15 numerals, and therefore there are printed the first 12 in this field;
field 43: Derivative Code, comprising the last three numerals of the ISO-compatible Integral Code (to be used to form the Resulting Code);
field 44: Derivative Code coincident with its respective Integral Code, attributed to the animal for handling purposes, formed by five characters whereof three are letters and two are numerals. This Derivative Code comprises the last three characters of the Integral Code assigned to the animal by the controlling organization, which is fully printed on the button-type ear tag as shown in FIG. 9-a.

As may be noted in FIG. 9-b, the Codes recorded in the conventional ear tag are sufficient to individualize the animal according to the principles of the present invention, since both the first Derivative Code “P72AR” and the second Derivative Code “686” are printed on the said conventional ear tag, which facilitates the entry of the individualization of the animal in a handled animals spreadsheet, such as the one given as example in FIG. 6. Such as occurs with the conventional ear tag, there may be used the button-type ear tag to carry both pieces of information that help to individualize the animal, and this option is depicted in FIG. 10. In this figure, the first Integral Code “235904383615795” is fully recorded in field 45, and the respective Derivative Code is formed, in this case, by the numerals recorded in larger font/print size, that is, “795”. The second Derivative Code “643052”, which in this case is coincident with its own Integral Code, is in field 46, separated by two lines of field 45. To facilitate the work of the laborers, there were included the optional arrows that indicate the reading direction.

### GLOSSARY

In the following there are defined some terms and expressions used in the present document:
Code: a sequence of characters formed in accordance with an official or non-official standard;
Integral Code: a complete code that individualizes an animal for a certain purpose, generated in accordance with criteria established in official standards such as the ISO or similar standards, the SISBOV standards, the standards adopted by breeder entities or associations, or yet, codes assigned to the animal on a private basis;
Derivative Code: a set of characters contained in the Integral Code, visually perceptible in the animal;
Specific Signal: a characteristic, or a set of characteristics, that is visually perceptible, inherent or attributed to the animal by marking or attachment; and which may refer to:
   the gender, color or race of the animal;
   the color, size, location or positioning of the Identification Element(s) attached to the animal;
   one or more characters marked on the animal by means of branding with fire or tattooing or available in the Identification Element such as the month of birth, year of birth or codifications of blood type, herd of birth, property where the animal was born, parents of the animal; or
   one or more graphic signs branded on the animal with fire or tattooing or available in the Identification Element as the owner's mark, the mark of the breeders association, or any other;
Resulting Code: a code formed by the combination of two or more Derivative Codes visually perceptible on the animal, at least one of these consisting in a portion of the Integral Code, and which may further include one or more Specific Signals, organized in the order established by the persons in charge of the system;
Identification Element: a physical support means wherein is recorded the Integral Code or the Derivative Code or the Specific Signal, and which may consist in a conventional or button-type ear tag, a tattoo, a neck collar or a marking;
Input/entry: recording of Derivative Codes, Specific Signals and/or information on the handling actions performed in respect of the animals, in the fields of a spreadsheet.

1. A method of individualizing animals and herd management to facilitate the collection and inclusion of information regarding handling actions performed in respect of the animals, at any phase of breeding thereof, in a database, characterized in that the animal is unambiguously individualized by means of the combination of two or more Derivative Codes, visually perceptible on the animal, at least one of these constituting a portion of its respective Integral Code.

2. A method as claimed in claim 1, characterized in that the resulting code also includes one or more specific signals comprising a characteristic or a set of characteristics that is visually perceptible on, inherent or attributed to the animal by branding or attachment.

3. A method as claimed in claims 1 or 2, characterized in that one or more of the respective integral codes is/are compatible with the standard ISO 11784 or similar standards.

4. A method as claimed in claims 1 or 2, characterized in that one or more of the respective integral codes is/are a code that is not compatible with the ISO standards, but is attributed to the animal by any specific entity, or by the owner thereof, or by the herd manager, or is any other code that individualizes the animal within the herd or group managed.

5. A method as claimed in claim 1, characterized in that the numerals or characters selected among those forming the integral code, used to form the derivative code, occupy contiguous positions.

6. A method as claimed in claim 1, characterized in that the numerals or characters selected among those that form the integral code, used to form the derivative code, occupy non-contiguous positions.

7. A method as claimed in claim 1, characterized in that the identification element comprises, non-exclusively, an integral code, a derivative code or a specific signal.

8. A method as claimed in claim 1, characterized by comprising the entry and insertion of derivative codes, specific signals and/or information on handling actions performed in respect of the animals, in a spreadsheet.

9. A method as claimed in claim 1, characterized in that the entry of one or more of the said specific signals or of the said specific signal coding is conditional upon messages generated by a data processing equipment.

10. A system for individualizing animals and managing herds, characterized by comprising two or more derivative codes, at least one of which constituting a portion of the integral code, and which may also include one or more specific signals existing in the animal such that they enable the visual individualization thereof and comprising the entry of the individual information relative to each animal.

11. A system as claimed in claim 10, characterized in that the said entry means are provided in the form of spreadsheets comprising fields for manual registration of the derivative codes as well as of the specific signals of the animal.

12. A system as claimed in claims 10 or 11, characterized in that the said fields occupy non-adjacent positions in the said spreadsheet.

13. A system as claimed in claim 10, characterized in that the said entry means are provided in the form of data input devices associated to data processing equipment.

14. A system as claimed in claim 13, characterized in that the said equipment is provided with speech recognition means.

15. A system as claimed in claims 13, characterized in that the said data processing equipment is provided with a touch screen.

16. A system as claimed in claim 13, characterized in that the said data processing equipment is provided with a specific software which retrieves from the database the various correlated integral codes that independently individualize the animal for various purposes, as well as the data previously stored in the said database, based on the interpretation of the information introduced by means of the said data input devices, according to procedures and routines related to the combination of the said information previously defined by the persons in charge of the system for such case.
